(19) United States
(12) Patent Application Publication
(10) Pub. No.: US 2015/0128594 A1
(43) Pub. Date: May 14, 2015

(54) Heat Transfer Fluid Flow Rate and Temperature Regulation System

(71) Applicant: eSolar Inc., Burbank, CA (US)

(72) Inventors: Gaurav Soni, Sunnyvale, CA (US); Michael Slack, South Pasadena, CA (US)

(73) Assignee: eSolar Inc., Burbank, CA (US)

(21) Appl. No.: 14/538,795

(22) Filed: Nov. 11, 2014

Related U.S. Application Data
(60) Provisional application No. 61/902,741, filed on Nov. 11, 2013.

(51) Int. Cl. F03G 6/06; F22B 1/06; F24J 2/46; F22B 1/00; F24J 2/40; F24J 2/34

(52) U.S. Cl. CPC F03G 6/067; F24J 2/402; F24J 2/34; F24J 2/4649; F22B 1/006; F22B 1/06
USPC 60/641.15; 165/104.28; 126/640; 165/297; 165/298; 60/676

(57) ABSTRACT

A system for regulating the temperature and flow rate of a heat transfer fluid for use in a hybrid steam-generating plant is described. A bypass section may be incorporated into the piping network of a primary steam-generating source to route heat transfer fluid from a hot source to a mixer downstream of at least one heat exchanger. Heat transfer fluid from the hot source may be mixed with cooler heat transfer fluid exiting the heat exchanger in the event that the supply from a secondary steam-generating source is lost or becomes intermittent. The result is a system that maintains a constant flow rate of heat transfer fluid through the heat exchangers while minimizing adverse temperature gradient effects that may result from steam production variability and plant operation outside of design point parameters.

### CROSS-REFERENCES TO RELATED APPLICATIONS

The present application claims priority to and the benefit of U.S. Provisional Patent Application No. 61/902,741, filed on Nov. 11, 2013, the entire disclosure of which is incorporated herein by reference.

### BACKGROUND OF THE INVENTION

This invention relates generally to systems that employ a heat transfer fluid to convert water into steam. In particular, the invention relates to an improved temperature and flow rate regulation system for heat transfer fluid in a hybrid steam-generating system.

In some industrial applications, a hot heat transfer fluid (such as molten nitrate salt, hot air, or oil) is used for heating a colder working fluid (such as water). The result is the production of a heated working fluid (e.g. steam) that may be used for various applications that may include, but are not limited to, power generation, enhanced oil recovery, desalination, and domestic and industrial process heating. A heat transfer fluid (HTF) is generally seen as a stable source of industrial process heat because it can either be stored in tanks for later consumption (such as in conjunction with a concentrating solar plant) or utilized immediately upon preparation (such as in conjunction with a fossil fuel-fired HTF heater). There do exist, however, several sources of heat which are intermittent in nature, such as steam generated from concentrating solar plants with no thermal storage, or fossil plants without constant fuel supplies (e.g. power plants that consume biomass). In certain circumstances it may be desirable to combine such intermittent sources with stable HTF-based heating systems. Such hybridization can not only improve the reliability of the intermittent source's availability but may also reduce the cost of an HTF-based system. For example, when a Concentrating Solar Power (CSP) plant having thermal storage for a heat transfer fluid is hybridized with another CSP plant having no such storage, the hybrid plant exhibits a higher capacity factor at a lower equivalent cost of additional storage tanks and HTF inventory.

As described above, an example of a hybridized steam-generating system may comprise a CSP plant. Concentrating solar power plants are now becoming commercially viable alternatives to conventional power generation by fossil fuels. Such power systems typically employ a field of reflectors that direct sunlight onto receivers containing water or a heat transfer fluid. If the receiver contains water, it may be converted into steam and then used for various applications such as those mentioned previously. If the receiver contains a heat transfer fluid other than water, the hot fluid may be used to convert water into steam for similar applications. CSP plants utilizing an HTF may be integrated with energy storage systems to allow for continued energy production at night or for shifting peak energy production to periods exhibiting heavy energy demand and low sunlight conditions. One problem with energy storage solutions is that they can present a large capital cost to the development of a plant. Large insulated containers must be built to house heat transfer fluid until it is needed, and the quantity of requisite fluid must be increased to meet the flow rate necessary to operate the plant at maximum capacity. It is possible, however, to construct a hybrid plant that combines a primary steam-generation source with a secondary steam-generation source. For example, a CSP installation having thermal energy storage may be hybridized with a fossil-fuel power plant. The secondary steam-generation source can augment the production of the primary steam-generation source and supplement daily output such that the hybrid plant exhibits the same capacity factor as a stand-alone HTF-based system at a reduced cost and with less energy storage infrastructure.

When an HTF-based steam-generator is hybridized with an intermittent secondary steam source, the HTF storage system may have to compensate for the shortfall in the output of the secondary steam source in order to maintain a steady output of working fluid. In the case of a CSP plant that produces steam as a working fluid, this shortfall may be due to the intermittent nature of solar generation. Causes of intermittency in solar generation may include adverse weather, overcast conditions, and diurnal variations in direct normal insolation (DNI). For fossil fuel power plants, the intermittency may be caused by fluctuations in fuel supply (e.g. biomass). Shortfalls such as these can lead to large operational swings in the output of an HTF-based steam-generator; these swings may require dynamically variable input conditions that can make the steam-generator difficult to design. Therefore, there exists a need to improve the regulation of the both the temperature and the flow rate of a heat transfer fluid in an HTF-based steam-generator to make integration with a secondary steam source easier and more efficient.

### SUMMARY OF THE INVENTION

An improved process for regulating the temperature and flow rate of a heat transfer fluid in a hybrid steam-generating system is described herein, wherein the heat transfer fluid may be distributed via at least one piping network that comprises at least one fluid flow bypass to circumvent at least one heat exchanger, and additional mixing stages to maintain the heat transfer fluid flow rate and temperature at desired levels during system operation.

The primary steam source in a hybrid steam-generating system may be a Concentrating Solar Power (CSP) plant having a receiver containing a heat transfer fluid. The heat transfer fluid may be heated to high temperatures by sunlight directed from reflectors or heliostats onto the receiver. The CSP system may comprise a storage module for stable operation. The storage module may comprise a hot tank containing the heat transfer fluid at a hot temperature and a cold tank containing the heat transfer fluid at a cold temperature, wherein the difference between the hot temperature and the cold temperature may determine the heat transfer fluid inventory and the steam production capacity of the system. The heat transfer fluid may be selected from air, oils, of from molten salts comprising a mixture of potassium nitrates and sodium nitrates. The steam-generating system may comprise a primary steam-generator having a first piping network through which the heat transfer fluid may be distributed. The primary steam-generator may also comprise at least one heat exchanger to which heat transfer fluid flow may be directed and within which the heat transfer fluid may be used to produce hot water or steam. At least one of the heat exchangers may comprise at least one Superheater configured to output superheated steam. In power generation applications, at least one of the heat exchangers may also comprise a Reheater. Superheated steam may be delivered via the first piping network from the Superheater(s) to at least one high pressure turbine where it may be utilized to generate power. After passing through the turbine steam expands, lowering its temperature and pressure. For this reason the expanded steam may be routed to a Reheater, where heat transfer fluid may be used to heat the steam back to a superheated temperature. This reheated steam may then be routed to at least one intermediate pressure turbine for additional power generation. The steam-generator may also be used for various other applications which may or may not require reheating.

After heating steam to superheated temperatures in Superheaters or a Reheater, the cooled heat transfer fluid output from the at least one heat exchanger may be mixed with the heat transfer fluid output from additional heat exchangers in a Mixer, wherein the mixture is brought to an equilibrium temperature. The heat transfer fluid may then be routed to an Evaporator which converts warm feedwater into steam. The Evaporator may in turn be connected via the first piping network to a Preheater that may initiate preliminary heat transfer to cold or pre-heated feedwater. Finally the heat transfer fluid, having cooled during its progression through the first piping network, may be deposited in a cold tank.

Secondary steam-generation sources may comprise, but are not limited to, linear Fresnel solar fields, direct steam solar power towers, solar trough fields, and water heaters powered by coal, natural gas or other fossil fuels. The secondary steam may be distributed through a second piping network and may be integrated with the primary steam at various locations. The secondary steam may be mixed with the output of an Evaporator in the primary steam-generator. In this configuration, the steam mixture may then be routed via the first piping network to a Superheater. The Evaporator may be considered to be a heat exchanger that produces saturated steam (though not necessarily exhibiting 100% quality), and the Superheater may be considered to be a heat exchanger that dries the steam and raises its temperature. The Superheater may be designed to accept a mixture of steam produced by both the Evaporator and the secondary steam source.

When secondary steam is not available or supplies less than the desired portion of the total steam fraction, the heat transfer fluid may become the only or primary source of heat for producing steam. When the secondary steam source is fully available, the heat transfer fluid demand may be correspondingly reduced. To optimize the sizing of the hybrid system and control costs, the primary and secondary steam sources may each be allocated a portion of the requisite steam-generation by the hybrid plant. The ratio of total steam generated by the primary steam source to the total steam flow defines the primary steam fraction and the corresponding ratio of steam generated by the secondary steam source to the total steam flow defines the secondary steam fraction.

The availability of the secondary steam source may be random and vary rapidly, which may require the heat transfer fluid flow rate to vary as well. When the secondary steam fraction is lower than a predetermined design value, the Evaporator in an HTF-based steam-generating system may have to compensate for this shortfall by producing additional steam. This requires a higher flow rate and temperature of the HTF at the inlet of the Evaporator. When the flow rate of HTF entering a heat exchanger such as a Superheater or Reheater increases, the HTF enters these heat exchangers at increased temperatures. As a result, both the flow rate and the temperature of the HTF are increased at the inlet of the Evaporator during times of secondary steam shortfall. Likewise, when the secondary steam fraction increases, the primary steam fraction is correspondingly decreased and the flow rate of the heat transfer fluid from the hot side of the heat transfer distribution system is lowered. Lowering the flow rate of the heat transfer fluid will lower its temperature at the outlet of the at least one heat exchanger (i.e. Superheater and Reheater). As a result, the flow rate and temperature of available HTF at the inlet of the Evaporator will go down in when the availability of secondary steam increases.

While variations in temperature and flow rate of the HTF do not inhibit the ability of the Evaporator to maintain a steady flow of output steam, the other heat exchangers (i.e. Superheater and Reheater) are subject to stressors from such large thermal swings during operation. As discussed above, the Superheater and Reheater receive a constant supply of steam, but the flow rate and exit temperature of the HTF can vary significantly. To illustrate, the HTF exit temperature from the heat exchangers may vary by up to 100° C. and the HTF exit flow rate from the heat exchangers may vary by up to 100%. These operational variations make the heat exchangers more difficult and costly to design, as the enclosure material becomes vulnerable to thermal cycling and stresses induced by temperature and pressure gradients. This makes the system less efficient for its cost and presents an opportunity for improved design.

To alleviate the problem of the heat transfer fluid having a different temperature when exiting at least one heat exchanger depending on the availability of the secondary steam source, a fluid bypass within the first piping network is proposed. The fluid bypass may comprise piping members downstream of the HTF source (such as a hot tank) and upstream of the heat exchangers, wherein the fluid bypass may divert a portion of the heat transfer fluid from the hot tank to a fluid mixer. The fluid mixer may also receive additional input of cooled heat transfer fluid exiting other heat exchangers. In the fluid mixer, the maximum temperature heat transfer fluid from the HTF source may mix with cooled heat transfer fluid from the heat exchangers before it flows into the other stages of the system. When the secondary steam source is inactive or supplying diminished output, an increased flow rate of heat transfer fluid may be sent through the bypass to compensate for the shortfall of the secondary steam source without changing the total flow rate through the heat exchangers. Similarly, when the secondary steam source is active and supplying the desired output, the heat transfer fluid flow rate through the bypass may be reduced to accommodate the presence of the secondary steam, again without modifying the flow rate through the heat exchangers.

With the use of a bypass, the flow rate of the heat transfer fluid into the heat exchangers may therefore remain constant regardless of the availability of the secondary steam source. The temperature and flow rate of HTF entering the heat exchangers may also be varied by mixing bypass flow with heat exchanger exit flow. The result is a steam-generating system designed to regulate heat transfer fluid flow rates and temperatures to reduce thermal stresses on the heat exchangers, thereby lowering material costs and making a hybrid plant more robust to intermittent availability of a secondary steam source.

### BRIEF DESCRIPTION OF THE DRAWINGS

FIG. 1 is a systems depiction of a conventional hybrid steam-generating plant configuration comprising a primary steam-generating source utilizing a stable source of heat transfer fluid and a secondary steam-generating source comprising an intermittent source of steam.

FIG. 2 is an example of a conventional hybrid steam-generating plant configuration according to the embodiment disclosed in FIG. 1, comprising a primary steam-generating source utilizing a solar reflector field with a molten salt receiver and a secondary steam-generating source comprising a secondary steam source, wherein the secondary steam-generating source supplies zero output of steam.

FIG. 3 is an example of a conventional hybrid steam-generating plant configuration according to the embodiment disclosed in FIG. 1, comprising a primary steam-generating source utilizing a solar reflector field with a molten salt receiver and a secondary steam-generating source comprising a secondary steam source, wherein the secondary steam-generating source supplies a non-zero output of steam.

FIG. 4 is a systems depiction of an improved hybrid steam-generating plant configuration according to an embodiment of the present invention, comprising a primary steam-generating source utilizing a heat transfer fluid and a secondary steam-generating source utilizing a secondary steam source, wherein the primary steam-generating source further comprises a first piping network comprising a fluid bypass section connected to a fluid mixing stage, and wherein the secondary steam-generating source supplies an intermittent output.

FIG. 5 is an example of an improved hybrid steam-generating plant configuration according to the embodiment disclosed in FIG. 4, comprising a primary steam-generating source utilizing a solar reflector field with a molten salt receiver and a secondary steam-generating source comprising a secondary steam source, wherein the primary steam-generating source further comprises a first piping network comprising a fluid bypass section connected to a fluid mixing stage, and wherein the secondary steam-generating source supplies zero output.

FIG. 6 is an example of an improved hybrid steam-generating plant configuration according to the embodiment disclosed in FIG. 4, comprising a primary steam-generating source utilizing a solar reflector field with a molten salt receiver and a secondary steam-generating source comprising a secondary steam source, wherein the primary steam-generating source further comprises a first piping network comprising a fluid bypass section connected to a fluid mixing stage, and wherein the secondary steam-generating source supplies a non-zero output.

FIG. 7 is a systems depiction of an improved hybrid steam-generating plant configuration according to an additional embodiment of the present invention, comprising a secondary fluid bypass section that directs heat transfer fluid to the heat exchangers to prevent fluid freezing.

FIG. 8 is an example of an improved hybrid steam-generating plant configuration according to the embodiment disclosed in FIG. 7, wherein heat transfer fluid from a hot tank is mixed with heat transfer fluid exiting at least one heat exchanger to prevent freezing of the heat transfer fluid.

DETAILED DESCRIPTION OF THE PRIOR ART

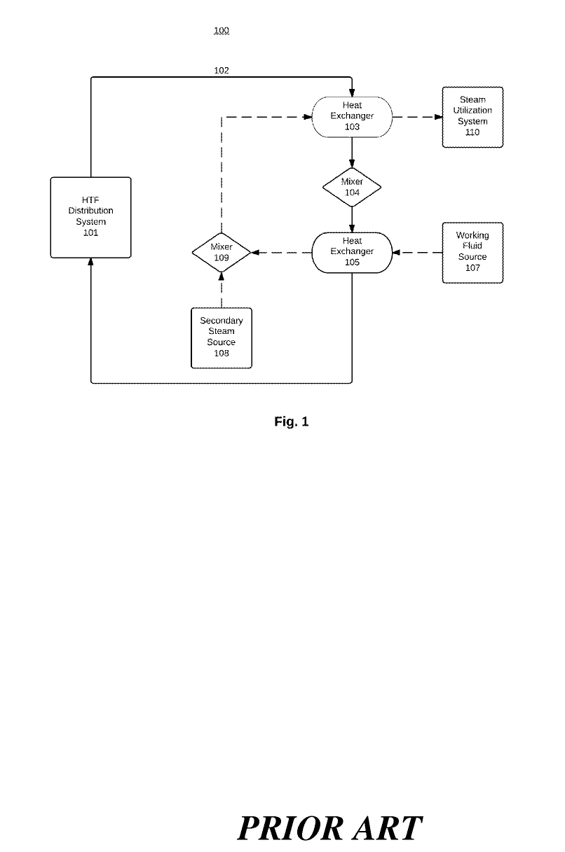

To better illustrate the novelty of the present invention over the prior art, a conventional heat transfer fluid distribution and temperature regulation system is described herein with references to FIGS. 1-3. In FIG. 1, a conventional hybrid steam-generating plant 100 may comprises a primary steam-generating source and a secondary steam-generating source. The primary steam-generating source may comprise a heat transfer fluid distribution system 101 having hot and cold sources of a heat transfer fluid (HTF). Heat transfer fluid may be housed in separate tanks for cold and hot sources, or it may housed in the same repository that has been segmented into hot and cold regions, such as in a thermocline.

In a conventional steam-generating plant an outlet of the HTF distribution system may be connected by way of a piping network 102 to at least one secondary heat exchanger 103. The secondary heat exchangers may comprise Superheaters, Reheaters, or a combination thereof. Heat transfer fluid in the secondary heat exchangers may be used to supply heat to a working fluid, such as steam. Heat transfer fluid outlet flow from the heat exchangers may be collected in a mixer 104 and brought to an equilibrium temperature. The mixer may be connected by way of the piping network to at least one primary heat exchanger 105, wherein working fluid may be first heated or converted into a usable state. The primary heat exchangers may comprise an Evaporator, Preheater, Superheater, or a combination thereof. Working fluid may enter the primary heat exchanger(s) from a working fluid source 107.

The secondary steam-generating source may comprise secondary steam source 108. Steam from the secondary steam source may be mixed with steam exiting the primary heat exchangers in mixer 109. The steam mixture may then be then routed to the secondary heat exchangers. Ultimately, steam heated via the secondary heat exchangers 103 may be routed to a steam utilization system. The steam utilization system may use steam or superheated steam to facilitate operation of particular plant processes. To provide additional clarity with regards to FIG. 1 and all future figures, HTF fluid pathways through the piping network are indicated with solid lines, while steam pathways through the piping network are indicated with dashed lines.

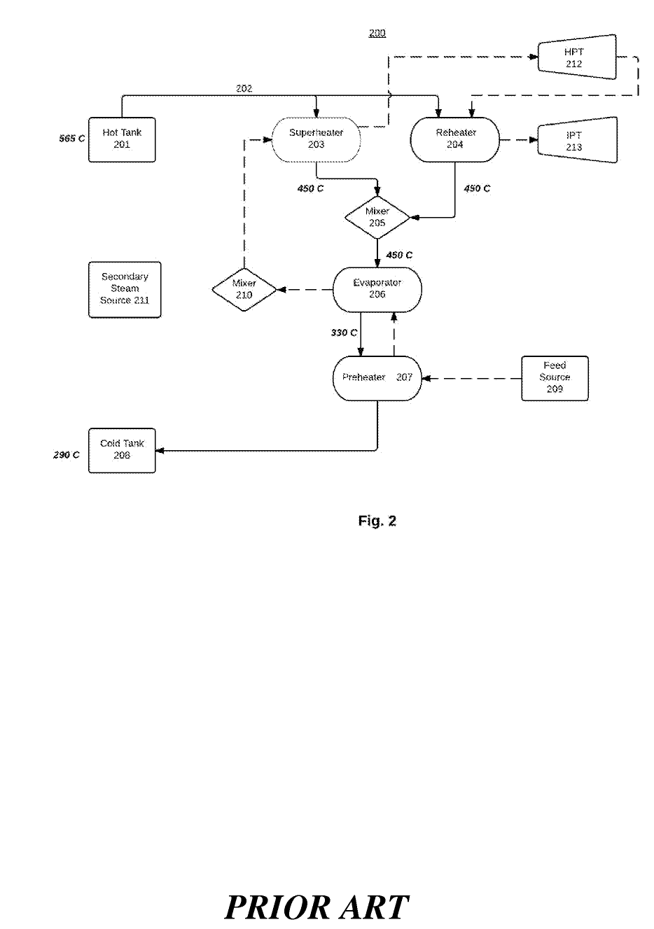

FIG. 2 displays an example of a conventional hybrid steam-generating plant 200 with zero contribution from the secondary steam-generating source. The primary steam-generating source may comprise a hot tank 201 containing molten salt at a temperature of 565° C. (degrees Celsius). The hot tank may be connected via piping network 202 to a Superheater 203 and a Reheater 204. Both the Superheater and the Reheater may be connected downstream to a salt mixer 205 which collects heat transfer fluid exiting the Superheater and the Reheater. The salt mixer outlet may be connected to an Evaporator 206, which outputs cooled heat transfer fluid to a Preheater 207. Heat transfer fluid exiting the Preheater may finally be collected in a cold tank 208.

Working fluid (such as water) may be converted into steam via the following process: water enters Preheater 207 from a feed source 209, where it is heated by the heat transfer fluid to an elevated temperature and then sent to the Evaporator 206, where it is converted into steam. Steam in the primary steam-generating source may then be routed to a steam mixer 210 that also may receive additional steam from a secondary steam source 211. In the present example configuration the mixed steam may be distributed to the Superheater 203 where the heat transfer fluid warms it to a superheated state. The superheated steam may then be sent to run a high pressure turbine 212. After passing through the high pressure turbine the steam expands, lowering its temperature and pressure. The expanded steam may then be sent to the Reheater 204, where heat transfer fluid is used to heat the steam back to superheated conditions. This reheated steam may then be routed to an intermediate pressure turbine 213 for additional power generation.

The secondary steam source may comprise, but is not limited to, outlet steam from concentrating solar plants, fossil plants, or water heaters. The outlet steam from the secondary steam source may be utilized to heat working fluid in the primary steam-generating source and provide a fraction of the total steam flow required for plant operations (e.g. power generation, heating, desalination or other industrial processes) with the balance of steam flow provided by the primary steam source. If the secondary steam source is intermittent, such as because of variable solar availability or a scarcity of fuel, the secondary steam source may supply less-than-desired or zero input to the primary-steam generating source at a given point during plant operation. If the secondary steam source is not available or cannot supply the requisite amount of steam, the primary steam-generating source must compensate accordingly. This can be accomplished by increasing the flow rate of heat transfer fluid from the HTF distribution system.

In the present example configuration exhibiting zero contribution of the steam fraction as coming from the secondary steam source, the flow rate of heat transfer fluid from the hot tank is at its maximum, or 100%. For illustrative purposes, heat transfer fluid exits the Superheater 203 and Reheater 204 on its way to the salt mixer 205 at 450° C. Because both sources of HTF in the salt mixer are the same temperature, the fluid entering the Evaporator is also 450° C. The heat transfer fluid may work in the heat exchanger to supply heat to the steam and so the HTF cools to 330° C. at the outlet. After passing through the Preheater, the HTF may be cooled even further to 290° C., which is then the temperature at which HTF resides in the cold tank.

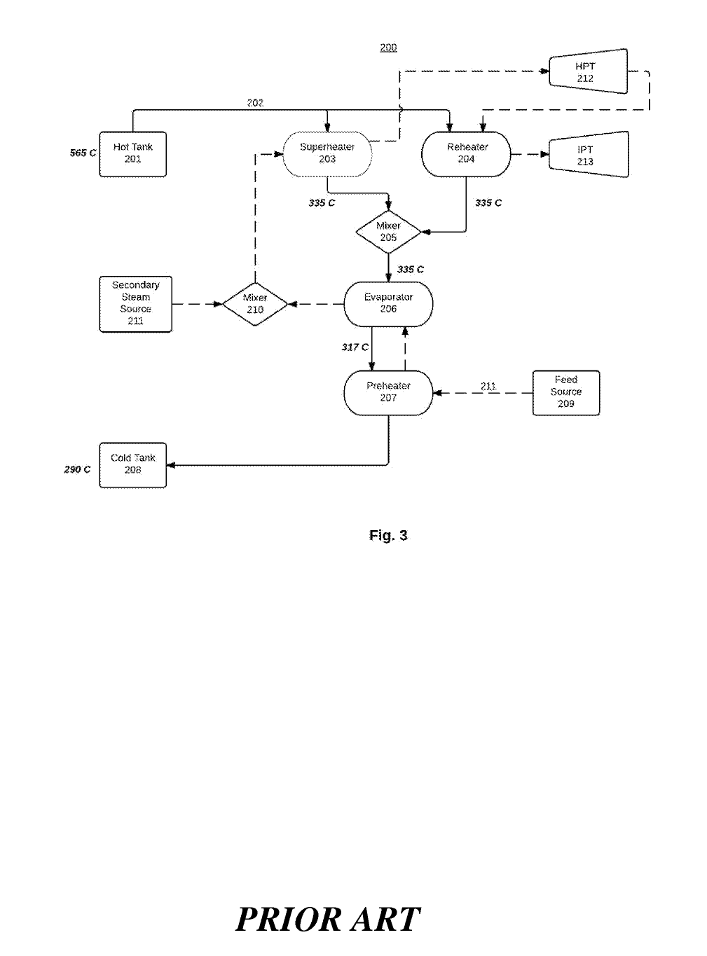

FIG. 3 displays an example of a conventional hybrid steam-generating plant with a non-zero contribution from the secondary steam-generating source. The present example configuration has the same layout as in FIG. 2, with the hot tank containing molten salt at a temperature of 565° C. If the secondary steam source provides a non-zero portion of the steam fraction (steam which is used to both convert working fluid to steam and also to heat the steam in the heat exchangers), the total thermal energy required from the molten salt in the hot tank will be lowered, and the flow rate of heat transfer fluid from the hot tank will be correspondingly reduced. The heat (amount of energy) of a heat transfer fluid is governed by the equation Q=\dot{m}CₚΔT where Q is the heat of the fluid, \dot{m}\dot{} is the mass flow rate, Cₚ is the heat capacity of the fluid at constant pressure, and ΔT is the change in the fluid's temperature. For a single phase fluid, Cₚ is nearly constant, and so when the flow rate \dot{m} decreases the fluid temperature at the heat exchangers must correspondingly decrease to supply the same amount of thermal energy Q. While the quantity ΔT actually increases during this process, the temperature of the salt in the hot tank stays the same (565° C.), and therefore the temperature at the outlet of the heat exchanger must be lower. Therefore, the result of a change in HTF flow rate is that the temperature of the heat transfer fluid exiting the heat exchangers 203 and 204 may decrease (335° C.) when the secondary steam source is fully available, and may increase (450° C., see FIG. 3) when the secondary steam source is less available, or not available at all. Changes in availability of the secondary steam source may thereby result in large swings in temperature of the HTF in heat exchangers of a hybrid steam-generating plant.

### DETAILED DESCRIPTION OF THE PREFERRED EMBODIMENTS

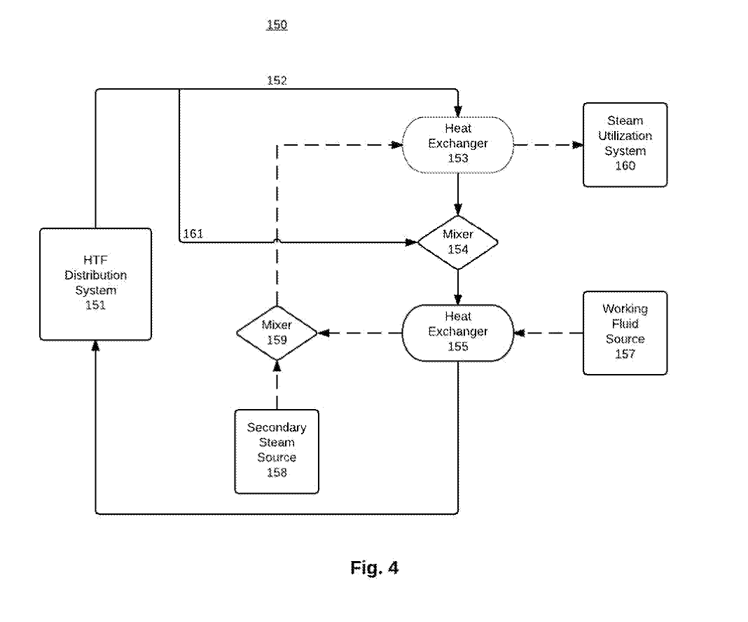

An improved heat transfer fluid distribution and temperature regulation system is described herein with references to FIGS. 4-8. FIG. 4 is a systems-level view of a first embodiment of the present invention: an example of a hybrid steam-generating plant 150 having an improved heat transfer fluid temperature regulation system. The hybrid plant may comprise both primary and secondary steam-generating sources. The primary steam-generating source may comprise a heat transfer fluid distribution system 151 having hot and cold sources of a heat transfer fluid. The hot and cold sources of the heat transfer fluid may be housed in the same repository or may be housed in separate repositories. The HTF distribution system may comprise heaters or may be heated by an external source. The HTF distribution system may additionally comprise a thermal storage apparatus for maintaining HTF temperatures when the system is non-operating. The heat transfer fluid may be selected from hot air, hot oils, or from molten salts comprising a mixture of potassium nitrates and sodium nitrates.

A piping network 152 may connect the HTF distribution system to at least one secondary heat exchanger 153. The secondary heat exchangers may comprise Superheaters, Reheaters, or a combination thereof. Heat transfer fluid in the secondary heat exchangers may be used to supply heat to a working fluid (such as steam). Heat transfer fluid outlet flow from the heat exchangers may be collected in a mixer 154 and brought to an equilibrium temperature. The mixer may be connected by way of the piping network to at least one primary heat exchanger 155, wherein working fluid may be first heated or converted into a usable state. The primary heat exchangers may comprise an Evaporator, Preheater, Superheater, or a combination thereof. Working fluid may enter the primary heat exchanger(s) from a working fluid source 157. Both the first and second steam-generating sources may utilize the same source of working fluid, or they may utilize separate sources.

The secondary steam-generating source may comprise secondary steam source 158. The secondary steam source may comprise linear Fresnel solar fields, direct steam solar power towers, solar trough fields, water heaters, fossil plants, or other suitable sources of intermittent steam generation. Steam from the secondary steam source may be mixed with steam exiting the primary heat exchangers in mixer 159. The steam mixture may then routed to the secondary heat exchangers 153. Steam heated via the secondary heat exchangers 153 may then be delivered to the steam utilization system 160. The steam utilization system may use steam or superheated steam to facilitate operation of particular plant processes. The steam utilization system may include, but is not limited to, power generators, enhanced oil recovery infrastructure, desalination facilities, and domestic and industrial process heaters.

As disclosed above with references to FIGS. 2 and 3, intermittent input from the secondary steam-generating source may cause the flow rate of heat transfer fluid from the distribution system to undergo swings that may induce thermal stress on the heat exchangers as the temperature of the fluid changes in response to variable flow rate. To solve this problem, the primary steam-generating source may additionally comprise a bypass piping section 161 that may connect a segment of the piping network 152 situated between the heat transfer fluid hot source in the HTF distribution system 151 and the secondary heat exchangers 153 to the heat transfer mixing stage 154. Heat transfer fluid from the heat transfer distribution system 151 may be controlled to divert fluid to any of the secondary heat exchangers 153 and the heat transfer mixing stage 154. Diverting heat transfer fluid via the bypass may maintain a constant flow rate of HTF to the topmost heat exchanger, i.e. the heat exchanger from which working fluid is routed to the steam utilization system 160.

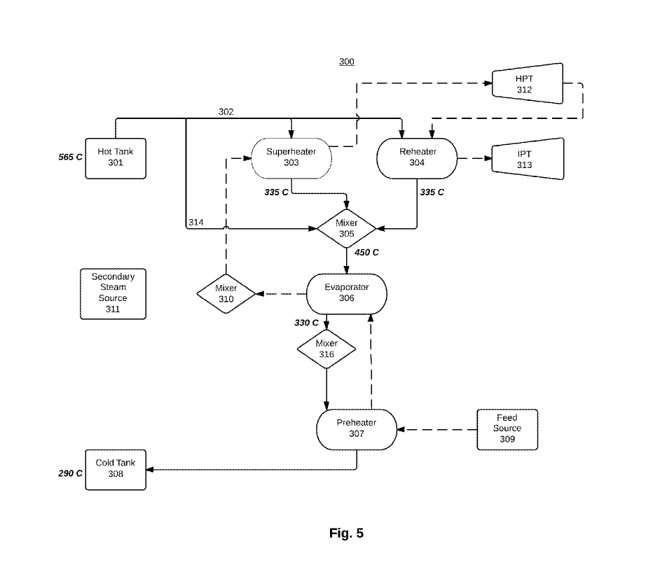

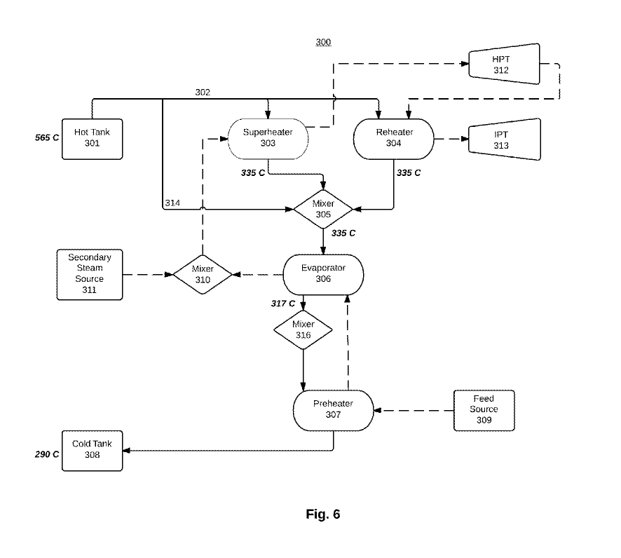

An example of how the bypass feature may be used to stabilize the heat transfer fluid flow rate is disclosed with reference to FIGS. 5 and 6. FIG. 5 is a systems-level view of an embodiment of the present invention: an example of a hybrid steam-generating plant 300 having an improved heat transfer fluid flow rate and temperature regulation system. In the present configuration, the system is depicted as receiving zero steam-fraction from the secondary steam-generating source.

The primary steam-generating source may comprise a hot tank 301 containing molten salt at a temperature of 565° C. (degrees Celsius). The hot tank may be connected via a piping network 302 to a Superheater 303 and a Reheater 304. Both the Superheater and the Reheater may be connected downstream to a salt mixer 305 which may collect heat transfer fluid exiting the Superheater and the Reheater. The salt mixer outlet may be connected to an Evaporator 306, which may output cooled heat transfer fluid to a Preheater 307. Heat transfer fluid exiting the Preheater may finally be collected in a cold tank 308, where it settles to 290° C.

If the working fluid is water, it may be converted into steam via the following process: water enters Preheater 307 from a feed source 309, whereupon it is heated by the heat transfer fluid to an elevated temperature and then sent to the Evaporator 306, where it is converted into steam. Steam in the primary steam-generating source may then routed to a steam mixer 310 that also may receive additional steam from a secondary steam source 311. As above, the secondary steam source may comprise, but is not limited to, outlet steam from concentrating solar plants, fossil plants, or water heaters. In the present configuration, the mixed steam may be distributed to the Superheater 303 whereupon the heat transfer fluid warms it to a superheated state. The superheated steam may then sent to run a high pressure turbine 312. After passing through the high pressure turbine the steam expands, lowering its temperature and pressure. The expanded steam may then be sent to the

Reheater 304, where heat transfer fluid may be used to heat the steam back to superheated conditions. This reheated steam may then be routed to an intermediate pressure turbine 313 for additional power generation.

The primary steam-generating source may additionally comprise a bypass piping section 314 that connects a segment of the piping network 302 located between the heat transfer fluid hot source (hot tank 301) and the secondary heat exchangers (the Superheater 303 and the Reheater 304) to the heat transfer mixing stage 305, wherein heat transfer fluid may be distributed from the heat transfer fluid hot source 301 to the secondary heat exchangers and the heat transfer mixing stage. Fluid flow from the piping network 302 via the bypass section 314 may be controlled by throughput-limiter valves (not shown) located at a terminus of the bypass section, such as at the inlet or outlet. The valve positions may be controlled by a centralized plant controller or manually operated in the event of intermittent steam generation from the secondary steam source 311.

In the present configuration exhibiting zero contribution of the steam fraction as coming from the secondary steam source 311, the flow rate of heat transfer fluid from the hot tank 301 is at its maximum, or 100%. In a conventional system (FIG. 2), this could result in the HTF at the exit of the Superheater and the Reheater having an elevated temperature of, for example, 450° C. To minimize thermal stresses at the secondary heat exchangers, a portion of the fluid flow from the hot tank 301 may be diverted through bypass 314 to the mixing stage 305. This would lower the flow rate of heat transfer fluid to the Superheater and the Reheater to levels commensurate with the flow rate seen when the secondary steam source is available and providing a non-zero input (FIG. 3). Thus, with the inclusion of the bypass the temperature of the molten salt exiting the secondary heat exchangers in the present example will remain steady at 335° C. HTF from the bypass 314 may mix with the colder HTF from the primary heat exchangers in the mixer 305 and settle to an equilibrium of 450° C. before the mixture is routed to the Evaporator 306. HTF in the Evaporator may be utilized to convert water into steam; the HTF may then cool to 330° C. in the process and may then be passed to the Preheater 307 and then to the cold tank 308, where it may reach an equilibrium temperature of 290° C.

FIG. 6 is a systems-level view of the same plant configuration as disclosed in FIG. 5, but with a non-zero steam fraction contribution from the secondary steam-generating source. As in the example depicted in FIG. 5, the system comprises a hot tank containing molten salt at a temperature of 565° C. Because the secondary source of steam is now available, the flow rate from the hot tank may be set at less than 100%. In the present configuration as depicted, the heat transfer fluid may exit the Superheater 303 and the Reheater 304 at 335° C. after being utilized to heat HTF in the secondary heat exchangers. Outlet HTF from the heat exchangers 303 and 304 may be sent to salt mixer 305. Flow rate through the bypass 314 may be reduced because thermal energy is being added to the system via secondary steam source 311.

By comparing the HTF regulation of a conventional steam-generating plant as depicted in FIGS. 2 and 3 to that of an improved steam-generating plant as depicted in FIGS. 5 and 6 it is clear that the addition of bypass line 314 improves the stability of the HTF distribution system by ensuring that the flow rate and temperature of heat transfer fluid exiting the secondary heat exchangers when the secondary steam source is fully available is the same as the flow rate and temperature when the secondary steam source is less available, or not available at all. Such an improvement minimizes the thermal stress experienced by the secondary heat exchangers and prolongs the lifespan of plant infrastructure.

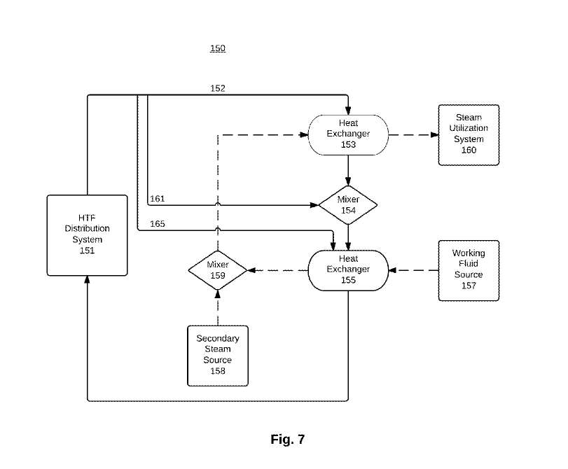

A second embodiment of the present invention is viewable in FIG. 7, which discloses a means to prevent freezing of HTF in heat exchangers without adversely affecting steam-generation. Many heat transfer fluids solidify if their temperature drops below a certain value. For example, a eutectic mixture of molten sodium nitrate and potassium nitrate salts may start to solidify between 220 and 240° C., well above ambient or room temperatures. In conventional steam-generating systems, the heat transfer fluid may flow from one heat exchanger to another in series. During this process the HTF temperature may decrease continually as it flows to successive stages. As a result, one or more heat exchangers may receive the HTF at very low temperatures and become vulnerable to freezing of the fluid. In conventional HTF-based steam-generating systems such as those depicted in FIGS. 2 and 3, it is the

Preheater which is most vulnerable to freezing because it receives HTF at the lowest temperature upstream of the cold tank. Additionally, heat transfer fluid may freeze in at least one heat exchanger under both design point and non-design point conditions. For example, during non-design operation (such as at the start of the operation of a plant on a cold morning), the balance of plant in a hybridized steam-generating system may supply very cold feedwater to a heat exchanger, resulting in an increased chance of freezing the heat transfer fluid flowing through it. Under such circumstances, HTF freezing may be prevented by diverting feedwater so as to bypass the heat exchanger altogether. However, this method adversely affects the system's steam-generation output because less heat will be transferred to the working fluid. An additional need exists for a means of preventing the freezing of heat transfer fluid without affecting steam-generation output.

In the proposed embodiment, the temperature and flow rate of HTF may be modulated at the entrance to a heat exchanger 155 vulnerable to fluid freeze conditions. The temperature and flow rate modulation of the HTF may be achieved by injecting hotter HTF from the HTF Distribution System 151 into the entrance of the heat exchanger 155 via a secondary fluid bypass piping section 165, which may be part of the piping network 152. Injection of hotter HTF at the inlet of the heat exchanger may raise both the inlet temperature and mass flow rate of the HTF mixture. As a result, the desired amount of heat may be transferred to water in the heat exchanger without subjecting the HTF to freezing point temperatures. The hotter salt for injection at the inlet may be obtained from various locations in the piping network, such as the HTF Distribution System (e.g. the hot tank or the HTF heater) or from other nodes in the flow path of the heat transfer fluid. The HTF may also be routed to a mixing stage separate from, and connected to, said heat exchangers; in this configuration the mixture of HTF from the bypass and HTF from other heat exchangers or mixing stages may be combined to warm the fluid entering a heat exchanger susceptible to fluid freezing conditions. The flow rate of hotter HTF required to prevent freezing depends on the original HTF inlet temperature and flow rate, the temperature and flow rate of the working fluid entering the heat exchanger, and the size of the heat exchanger. The flow rate of hotter HTF may be controlled by flow limiting devices such as valves. The increased HTF flow rate and temperature at the inlet to the heat exchanger obviates a need for additional feedwater heating and maintains the steam-generation output of the system.

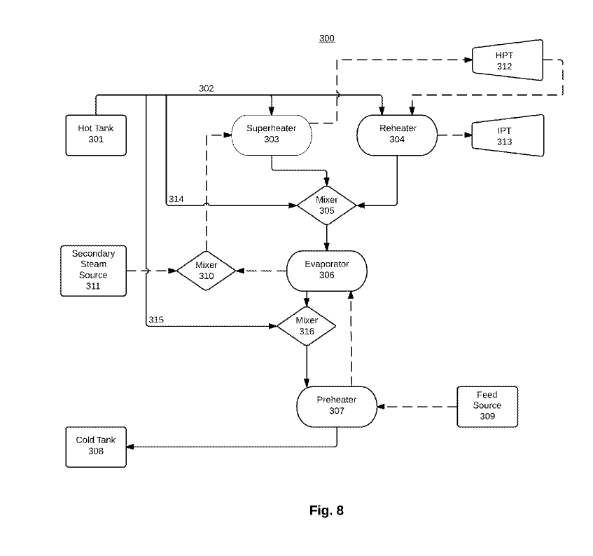

An example of a steam-generating plant exhibiting the features of the present embodiment is shown in FIG. 8. The plant layout is similar to that described in FIG. 5, but incorporates an additional fluid bypass piping section line 315 connected to piping network 302 that delivers heat transfer fluid from the hot tank 301 to a mixing stage 316 between primary heat exchangers. In the present configuration HTF from the Hot tank may be directly mixed with colder HTF exiting the Evaporator 306. The mixture may then be sent from the mixing stage 316 to the inlet of the Preheater 307. If the water from Feed Source 309 is too cold (such as during plant startup in the winter), the steam-generating system according to the present embodiment will be less vulnerable to the heat transfer fluid freezing and solidifying.

Ultimately a hybrid steam-generating plant according to the present invention may comprise fluid bypass piping sections connected from the heat transfer fluid distribution system, or the piping network connected to the heat transfer fluid distribution system, to any or all of the following: the primary heat exchangers, the secondary heat exchangers, and mixing stages connected to either the primary or secondary heat exchangers.

Various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention herein disclosed by way of examples should not be limited by the particular disclosed embodiments described above.

We claim:

1. A system for regulating the temperature and flow rate of a heat transfer fluid, the heat transfer fluid regulation system comprising:
a piping network through which a heat transfer fluid is distributed;
a second piping network through which a working fluid is distributed;
a heat transfer fluid cold source connected via said first piping network to at least one primary heat exchanger;
a heat transfer fluid hot source connected via said first piping network to at least one secondary heat exchanger;
a source of working fluid connected via said second piping network to the at least one primary heat exchanger;
a secondary steam source connected via said second piping network to a steam mixer;
a first heat transfer fluid mixer connected via said first piping network to the primary and secondary heat exchangers; and
a first bypass piping section connected to the first piping network and configured to distribute heat transfer fluid from the heat transfer fluid hot source to at least one secondary heat exchanger and the first heat transfer fluid mixer.

2. The heat transfer fluid regulation system of claim 1, wherein the first bypass piping section is connected to the first piping network at a location between the heat transfer fluid hot source and the at least one secondary heat exchanger

3. The heat transfer fluid regulation system of claim 1, wherein the heat transfer fluid is a molten salt.

4. The heat transfer fluid regulation system of claim 1, wherein the secondary steam source is one of linear Fresnel solar fields, direct steam solar power towers, solar trough fields, or water heaters.

5. The heat transfer fluid regulation system of claim 1, wherein the heat transfer fluid hot source is a tank containing hot heat transfer fluid.

6. The heat transfer fluid regulation system of claim 1, wherein the heat transfer fluid cold source is a tank containing cold heat transfer fluid.

7. The heat transfer fluid regulation system of claim 1, wherein the primary heat exchangers comprise at least one Superheater, Preheater, Evaporator or combination thereof.

8. The heat transfer fluid regulation system of claim 1, wherein the secondary heat exchangers comprise at least one Superheater, Reheater, or combination thereof.

9. The heat transfer fluid regulation system of claim 1, wherein the heat transfer fluid flow rate is controlled by at least one valve located at a terminus of the bypass piping section.

10. The heat transfer fluid regulation system of claim 9, wherein heat transfer fluid flows through the bypass piping section when the at least one valve is open and does not flow through the bypass piping section when the at least one valve is closed.

11. The heat transfer fluid regulation system of claim 9, wherein the flow rate of heat transfer fluid exiting the secondary heat exchangers when the bypass piping section is open is the same as said flow rate when the bypass piping section is closed.

12. The heat transfer fluid regulation system of claim 9, wherein the temperature of the heat transfer fluid exiting the secondary heat exchangers when the bypass section is open is equal to said temperature when the bypass piping section is closed.

13. The heat transfer fluid regulation system of claim 1, further comprising:
a second heat transfer fluid mixer connected to at least one of the primary heat exchangers; and
a second bypass piping section connected to the first piping network and configured to distribute heat transfer fluid from the heat transfer fluid hot source to the second heat transfer fluid mixer.

14. The heat transfer fluid regulation system of claim 13, wherein the second bypass piping section is connected to the piping network at a location between the heat transfer fluid hot source and the at least one secondary heat exchanger.

15. The heat transfer fluid regulation system of claim 1, wherein the heat transfer fluid transfers heat to the working fluid via the heat exchangers.

16. The heat transfer fluid regulation system of claim 13, wherein the working fluid is water.
